(19) United States
(12) Patent Application Publication
(10) Pub. No.: US 2019/0353594 A1
(43) Pub. Date: Nov. 21, 2019

(54) GAS SENSOR

(71) Applicant: Eaton Intelligent Power Limited, Dublin 4 (IE)

(72) Inventors: Alan MASSEY, Southampton Hampshire (GB); Yogesh SHINDE, Pune (IN)

(21) Appl. No.: 16/472,944

(22) PCT Filed: Dec. 20, 2017
(86) PCT No.: PCT/EP2017/083733

§ 371 Date: Jun. 24, 2019

(30) Foreign Application Priority Data
Dec. 23, 2016 (IN) 201611044084

(51) Int. Cl. G01N 21/61; G01N 21/17; G01N 21/21

(52) U.S. Cl. CPC G01N 21/61; G01N 2021/1727; G01N 21/21; G01N 21/1717

(57) ABSTRACT

A gas sensor includes: a gas chamber with a supply opening and a discharge opening, so as to permit gas to flow through the gas chamber; a magnetic field device for providing a magnetic field in the gas chamber; a light source for generating a light beam that extends through the gas chamber; and a detector for detecting the light beam, which detector is arranged opposite the light source.

### CROSS-REFERENCE TO PRIOR APPLICATIONS

This application is a U.S. National Phase application under 35 U.S.C. § 371 of International Application No. PCT/EP2017/083733, filed on Dec. 20, 2017, and claims benefit to Indian Patent Application No. IN 201611044084, filed on Dec. 23, 2016. The International Application was published in English on Jun. 28, 2018 as WO 2018/115076 under PCT Article 21(2).

### FIELD

The invention relates to a gas sensor, in particular an oxygen sensor.

### BACKGROUND

Gas sensors are used in a number of applications, such as in consumer, industrial, automotive and aerospace applications to monitor concentration of various gases. Monitoring of the O2 concentration is a common requirements among wide applications like, healthcare, HVAC systems, Hazardous areas, fuel tank systems etc.

However, oxygen sensors, especially known as lambda sensors require a high gas temperature, typically over 400° C., for the sensor to work. Those temperatures could provide a risk in certain processes and is not always suitable.

### SUMMARY

In an embodiment, the present invention provides a gas sensor, comprising: a gas chamber with a supply opening and a discharge opening, so as to permit gas to flow through the gas chamber; a magnetic field device configured to provide a magnetic field in the gas chamber; a light source configured to generate a light beam that extends through the gas chamber; and a detector configured to detect the light beam, which detector is arranged opposite the light source.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic view of a first embodiment of a gas sensor according to the invention.

FIG. 2 shows a schematic view of a second embodiment of a gas sensor according to the invention.

FIG. 3 shows a schematic view of a third embodiment of a gas sensor according to the invention.

### DETAILED DESCRIPTION

In an embodiment, the present invention provides a gas sensor, which can function at lower temperatures, especially at room temperature.

In an embodiment, the present invention provides a gas sensor, in particular an oxygen sensor, which gas sensor comprises:
a gas chamber with a supply opening and a discharge opening, such that gas can flow through the gas chamber;
a magnetic field device for providing a magnetic field in the gas chamber;
a light source generating a light beam, which light beam extends through the gas chamber; and
a detector for detecting the light beam, which detector is arranged opposite of the light source.

Some gases, like oxygen, exhibit paramagnetic properties when subjected to a magnetic field. These paramagnetic properties result in a local change in density or concentration of the gas at the position of the magnetic field.

With the invention a gas, showing paramagnetic properties, is subjected to a magnetic field and by using a light beam and detector for detecting the light beam, one can measure the change between the light beam when no magnetic field is present and when a magnetic field is present. Based on the difference one can calculate the concentration of the gas in the gas sensor.

In a preferred embodiment of the gas sensor according to the invention, the light beam extends through the magnetic field. As the density of the gases changes in the magnetic field, the light beam will be subjected to this change in density, which can be detected by the detector.

Preferably, the detector is a photo diode for detecting the intensity of the light beam. When the density of the gas increases, more of the light beam will be absorbed and less light will hit the photo diode. So by measuring the intensity of the light beam without a magnetic field and then measuring the intensity of the light beam with the magnetic field by the photo diode will result in a value, which corresponds to the concentration of gas in the gas chamber.

In another embodiment of the gas sensor according to the invention a second photo diode is provided, which second photo diode detects the intensity of the light beam upstream of the magnetic field.

With the second photo diode, the magnetic field can remain constant and does not need to be alternatingly switched on and off, in order to obtain a reference signal and a signal influenced by the concentration of the gas. The difference between the reference signal of the second photo diode and the photo diode of the detector will provide a constant indication of the concentration of gas flowing through the gas chamber.

In another preferred embodiment of the gas sensor according to the invention the magnetic field device comprises at least two electromagnets arranged on opposite sides of the gas chamber and parallel to the light beam.

By alternatingly switching one or the other electromagnet on and off, an oscillation in the output of the photo diode is achieved, which provides an indication for the concentration of the gas in the gas chamber.

Another option is to have a light beam extending through a hollow electromagnet, and by turning on and off said electromagnet a similar oscillation in the output of the photo diode can be obtained out of which the concentration of the gas can be derived.

In yet another embodiment of the gas sensor according to the invention, the detector is a wave length detector for detecting the wave length of the light beam.

When the magnetic field is oscillated, the wavelength of the light beam will be changed due to the oscillation in the density of the gas in the gas chamber. This change in wavelength provides again an indication for the concentration of the gas in the gas chamber.

In yet another embodiment of the gas sensor according to the invention the light source provides a polarized light beam having a wavelength matching to the absorption wavelength of the gas to be sensed with a maximum deviation of 10% and wherein the detector comprises a polarization detector to detect a change in the polarization of the light beam.

When the magnetic field is provided, the gas will exhibit its paramagnetic properties and accordingly change the orientation of the polarized light beam, which can be detected by the detector. For an efficient detection of the concentration of the gas in the gas chamber, the wavelength of the light beam should be in the same range as the maximum absorption wavelength of the gas, which should be detected by the sensor.

In yet another embodiment of the gas sensor according to the invention an optical grating, which is sensitive to changes in density of the gas in the gas chamber, is provided in the gas chamber, wherein the light beam is directed to the optical grating and wherein the detector comprises a light beam position sensor, which is arranged opposite of the optical grating.

Because the optical grating is sensitive to changes in the density of the gas in the gas chamber, the optical grating will change and the light beam directed to the optical grating will be diffracted. The angle of the light beam exiting from the optical grating thus changes which can be detected by the light beam position sensor. The amount of deviation of the position of the light beam provides an indication for the concentration of gas in the gas chamber.

The optical grating could be an acousto-optic crystal. By changing the magnetic field in the gas chamber, the density of the gas will change generating a pressure wave in the gas or an acoustic signal, which will be picked up by the acousto-optic crystal. As a result, the optical grating formed by the acousto-optic crystal will change depending on the pressure wave picked up by the crystal.

Yet another embodiment of the gas sensor according to the invention further comprising a control unit for controlling the magnetic field device such that a standing pressure wave is generated in the gas chamber.

The standing pressure wave will provide zones of high density and low density in the gas present in the gas chamber and as a result these alternating zones of high density and low density will provide an optical grating.

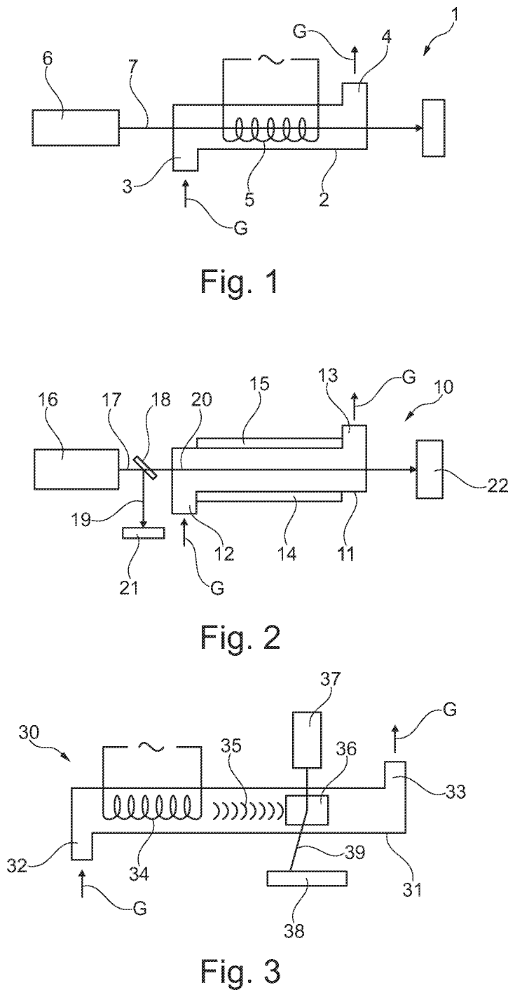

FIG. 1 shows a first embodiment 1 of a gas sensor according to the invention. The gas sensor 1 has a gas chamber 2 with a supply opening 3 and a discharge opening 4 arranged opposite of the supply opening 3. This allows for a gas flow of gas G through the gas chamber 2.

An electrical coil 5 is arranged in the gas chamber 5. The electrical coil 5 is supplied with an alternating current, such that a magnetic field is generated in the gas chamber 2.

A laser 6 generates a light beam 7, which extends through the gas chamber 2 and after exiting the gas chamber 2 the light beam is incident on a sensor 8. This sensor 8 could be a photo diode, which registers the intensity of the light beam 7 or which registers the wave length of the light beam 7. When a paramagnetic gas flows through the gas chamber 2, the magnetic field generated by the coil 5 ensures that the density of the gas changes, which has an effect on the amount of absorption of the light beam and/or the wavelength and/or the polarization of the light beam.

FIG. 2 shows a second embodiment 10 of a gas sensor according to the invention. The gas sensor 10 has a gas chamber 11 with a supply opening 12 and a discharge opening 13. Two electromagnets 14, 15 are arranged on opposite sides of the gas chamber 11.

A laser 16 generates a light beam 17, which is incident on a partial transparent mirror 18 to obtain two light beams 19, 20. The light beam 19 is deflected and hits a first photo diode 21 to provide a reference signal. Such a reference signal photo diode can also be applied to the embodiment of FIG. 1. The second light beam 22 extends straight through the gas chamber 11 and is incident on the second photo diode 22.

By alternating switching on and off the two electromagnets 14, 15 an oscillation will be generated in the signal generated by the photo sensor 22. The amplitude of this oscillation is a measure for the concentration of the gas G flowing from the supply opening 12 through the gas chamber 11 to the discharge opening 13.

FIG. 3 shows a third embodiment 30 of a gas sensor according to the invention. The gas sensor 30 has a gas chamber 31 with a supply opening 32 and a discharge opening 33.

An electrical coil 34 is arranged in the gas chamber 31. The electrical coil 34 is supplied with an alternating current to provide a magnetic field. By controlling the current supplied to the electrical coil 34, a pressure wave 35 can be generated in the gas.

An acousto-optic crystal 36 is provided downstream of the coil 34. This acousto-optic crystal 36 provides a changing optical grating depending on the incident pressure wave 35.

A laser 37 further generates a light beam 38, which is incident on the acousto-optic crystal 36, which will diffract the light beam 39, such that the angle of the light beam 39 is changed. With the position sensor 38 this angle of the light beam 39 can be determined and provides an indication for the strength of the pressure wave 35. Because the pressure wave 35 is the result of the paramagnetic properties of the gas G subjected to the magnetic field generated by the coil 34, it also provides an indication for the concentration of the gas G.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A gas sensor, comprising:
a gas chamber with a supply opening and a discharge opening, so as to permit gas to flow through the gas chamber;
a magnetic field device configured to provide a magnetic field in the gas chamber;
a light source configured to generate a light beam that extends through the gas chamber; and
a detector configured to detect the light beam, which detector is arranged opposite the light source.

2. The gas sensor according to claim 1, wherein the light beam extends through the magnetic field.

3. The gas sensor according to claim 2, wherein the detector comprises a photo diode configured to detect an intensity of the light beam.

4. The gas sensor according to claim 3, further comprising a second photo diode, which second photo diode is configured to detect an intensity of the light beam upstream of the magnetic field.

5. The gas sensor according to claim 2, wherein the magnetic field device comprises at least two electromagnets arranged on opposite sides of the gas chamber and parallel to the light beam.

6. The gas sensor according to claim 2, wherein the detector comprises a wave length detector configured to detect a wave length of the light beam.

7. The gas sensor according to claim 1, wherein the light source provides a polarized light beam having a wavelength equal to a maximum absorption wavelength of a gas to be sensed with a maximum deviation of 10%, and
wherein the detector comprises a polarization detector configured to detect a change in a polarization of the light beam.

8. The gas sensor according to claim 1, further comprising an optical grating, which is sensitive to changes in density of a gas in the gas chamber, the optical grating being provided in the gas chamber,
wherein the light beam is directed to the optical grating, and
wherein the detector comprises a light beam position sensor, which is arranged opposite the optical grating so as to detect a diffracted light spot position.

9. The gas sensor according to claim 8, further comprising a control unit configured to control the magnetic field device so as to generate a standing pressure wave in the gas chamber.

10. The gas sensor according to claim 1, wherein the gas sensor comprises an oxygen sensor.
